(19) United States
(12) Patent Application Publication
(10) Pub. No.: US 2010/0295749 A1
(43) Pub. Date: Nov. 25, 2010

(54) Radome for tracking antenna

(75) Inventors: Wayne Alan VANLIERE, Pittsburg, CA (US); Adrian Macdonald Nicholas, Danville, CA (US)

Correspondence Address: MORGAN, LEWIS & BOCKIUS, LLP (SF), ONE MARKET SPEAR STREET TOWER, SAN FRANCISCO, CA, 94105, US

(73) Assignee: Sea Tel, Inc., Concord, CA (US)

(21) Appl. No.: 12/784,640

(22) Filed: May 21, 2010

Related U.S. Application Data
(60) Provisional application No. 61/180,828, filed on May 22, 2009.

(51) Int. Cl. H01Q 1/42

(52) U.S. Cl. 343/872

(57) ABSTRACT

A radome for a tracking antenna system may include a dome for covering the tracking antenna, wherein the dome includes a dome wall having inner and outer skins sandwiching a low dielectric material layer therebetween, and wherein the dome wall includes a gel coat layer covering the outer skin to protect the dome in a marine environment. The inner and outer skins may have a thicknesses of approximately 0.007 to 0.027 inches, more preferably approximately 0.014 to 0.020 inches, and most preferably 0.017 inches. The low dielectric material layer may have a thickness of approximately 0.153 to 0.173 inches, more preferably approximately 0.160 to 0.166 inches, and most preferably 0.163 inches. The gel coat may have a thickness of approximately 0.010 to 0.030 inches, more preferably approximately 0.017 to 0.023 inches, and most preferably 0.020 inches. The tracking antenna system may include a tracking antenna having a resonant frequency of approximately 3 Hz to 5 Hz., and a radome including a base for supporting the tracking antenna and a dome secured to the base for enclosing the tracking antenna, wherein the base may have a resonant frequency above approximately 10 Hz.

### CROSS-REFERENCES TO RELATED APPLICATIONS

This application claims priority to U.S. Provisional Patent Application No. 61/180,828 filed May 22, 2009, entitled RADOME FOR TRACKING ANTENNA, the entire contents of which is incorporated herein for all purposes by this reference.

### BACKGROUND OF THE INVENTION

1. Field of the Invention

This present invention relates, in general, to a cover for tracking antenna and more particularly to radomes and methods for their construction and use.

2. Description of Related Art

Radomes are especially suitable for use aboard ship to cover tracking antenna systems operated to track a transmitting station, such as a communications satellite, notwithstanding roll, pitch, yaw, and turn motions of a ship at sea. Radomes are generally configured to protect the antenna and its associated structure from the environment.

Increased communications standards require higher performance from tracking antenna systems. For example, EUTELSAT continues to evolve their EESS 502 specification, with enforcement of receive band compliance and widening of the required elevation sweeps. Accordingly, it is increasingly challenging for antenna manufactures and vendors to keep current and stay ahead of these specifications in terms of compliance. Accordingly, it would be advantageous to have a radome having enhanced transparency.

In addition, tracking antenna systems generally have a resonant frequency. In instances where the resonant frequency of the radome or radome base are similar to that of the tracking antenna system, there is a danger that the resonant frequencies will contribute an increased range of relative motion between the radome and the system, which motion may cause impact and damage. Accordingly, it would be advantageous to have a radome base having resonant properties different than the resonant frequency of the supported tracking antenna system.

### BRIEF SUMMARY OF THE INVENTION

One aspect of the present invention is directed to a radome for a tracking antenna including a dome for covering the tracking antenna, wherein the dome includes a dome wall having inner and outer skins sandwiching a low dielectric material layer therebetween, and wherein the dome wall includes a gel coat layer covering the outer skin to protect the dome in a marine environment.

The inner and outer skins may have a thicknesses of approximately 0.007 to 0.027 inches, more preferably approximately 0.014 to 0.020 inches, and most preferably 0.017 inches. The low dielectric material layer may have a thickness of approximately 0.153 to 0.173 inches, more preferably approximately 0.160 to 0.166 inches, and most preferably 0.163 inches. The gel coat may have a thickness of approximately 0.010 to 0.030 inches, more preferably approximately 0.017 to 0.023 inches, and most preferably 0.020 inches.

Another aspect of the present invention is directed to a radome for a tracking antenna including a dome for covering the tracking antenna, wherein the dome includes a dome wall having inner and outer skins sandwiching a low dielectric material layer therebetween, wherein the inner and outer skins have a thicknesses of approximately 0.007 to 0.027 inches, more preferably approximately 0.014 to 0.020 inches, and most preferably 0.017 inches, and wherein the low dielectric material layer may have a thickness of approximately 0.153 to 0.173 inches, more preferably approximately 0.160 to 0.166 inches, and most preferably 0.163 inches.

Yet another aspect of the present invention is directed to a tracking antenna system including a tracking antenna having a resonant frequency of approximately 3 Hz to 5 Hz, and a radome including a base for supporting the tracking antenna and a dome secured to the base for enclosing the tracking antenna, wherein the base may have a resonant frequency above approximately 10 Hz.

The base may include a smooth circular body. The smooth circular body may have a frustoconical shape.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view of an exemplary radome for tracking antenna in accordance with various aspects of the present invention.

FIG. 2 is a side view of the radome of FIG. 1.

FIG. 3 is an enlarged detail “A” of FIG. 2.

FIG. 4 is a top view of the radome of FIG. 1.

FIG. 5 is a cross-sectional view of the radome of FIG. 1 taken along line A-A of FIG. 4.

FIG. 6 is an enlarged detail “B” of FIG. 5.

FIG. 7 is a perspective view of a tuned radome base of the radome of FIG. 1.

FIG. 8 is a top view of the radome base of FIG. 7.

FIG. 9 is a side view of the radome base of FIG. 7.

FIG. 10 is an enlarged top view of the radome base of FIG. 7 shown with a base spindle weldment for supporting a tracking antenna in accordance with the present invention.

FIG. 11A and FIG. 11B are top and inverted side views, respectively of the radome base of FIG. 7.

FIG. 12A to FIG. 12H are various detailed view the radome base of FIG. 7 as shown in FIG. 11A, FIG. 11B, and FIG. 12A.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In its simplest form the present invention is directed to a radome configured to enclose or substantially enclose a tracking antenna along with its associated structure and components which are configured to align a tracking antenna about three axis, an azimuth axis, a cross-level axis, and an elevation axis, such as those disclosed by U.S. Pat. No. 5,419,521 to Matthews, the entire content of which is incorporated herein for all purposes by this reference, as well as those used in the Sea Tel® 4006 and Sea Tel® 6006 Ku and other satellite communications antennas sold by Sea Tel, Inc. of Concord, Calif. In some aspects, the radome of the present invention is similar to those described by the above-mentioned '521 patent, as well as those used in the above-mentioned Sea Tel® Cobham 4006, Sea Tel® 6006, and other Sea Tel® Cobham satellite communications antennas.

In recent testing, a Sea Tel® Cobham 6006 antenna system, a marine stabilized satellite communications antenna system, was tested in a radome in accordance with the present invention. The Sea Tel® Cobham 6006 antenna system is a stabilized marine grade platform, on which a 1.5 m backfire parabolic satellite communications antenna is attached and placed in a 76″ radome. One will appreciate that the actual dimensions of the radome may vary depending upon the dimensions and configuration of the enclosed antenna system. The result found during testing showed vast improvement in performance of this antenna system housed in a radome of the present invention as compared to prior tests of this antenna housed in prior radomes.

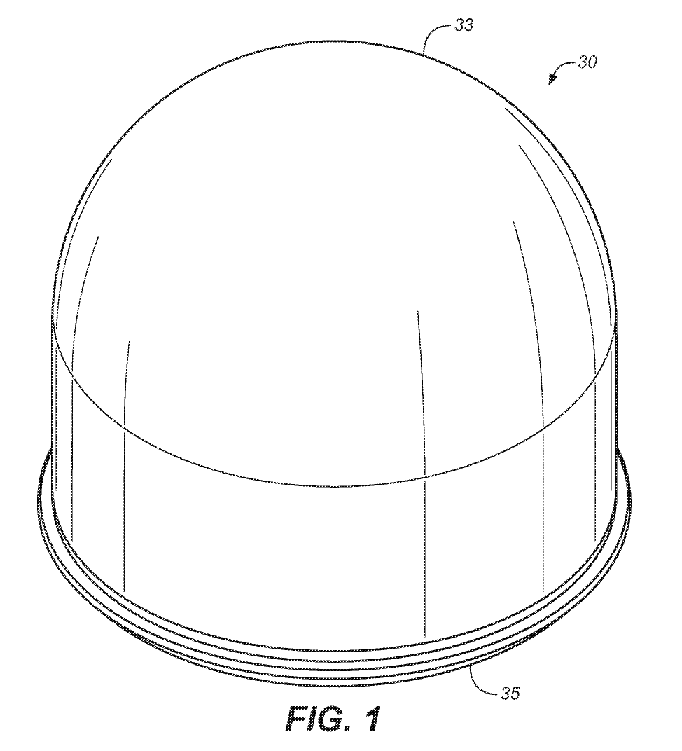

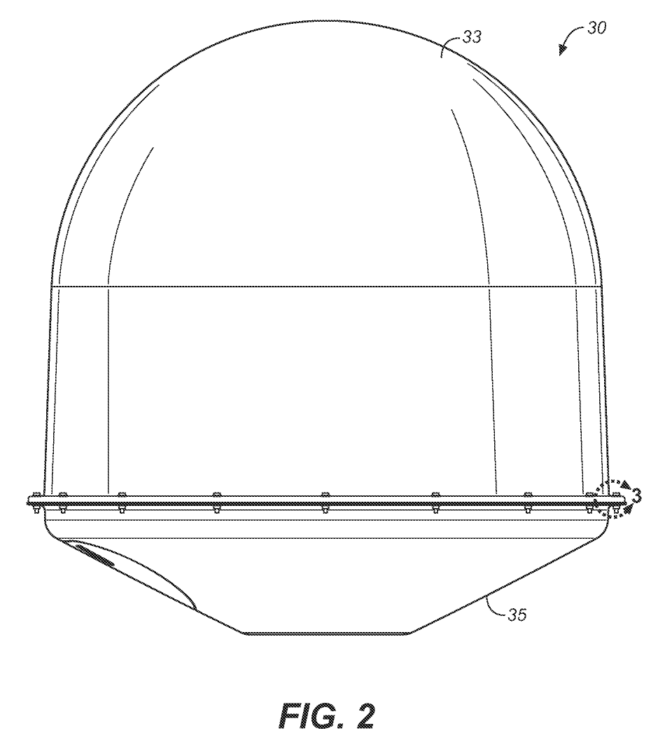

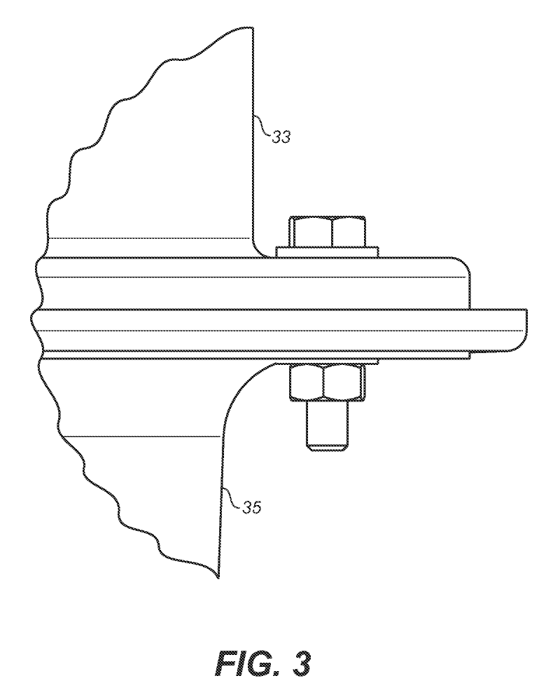

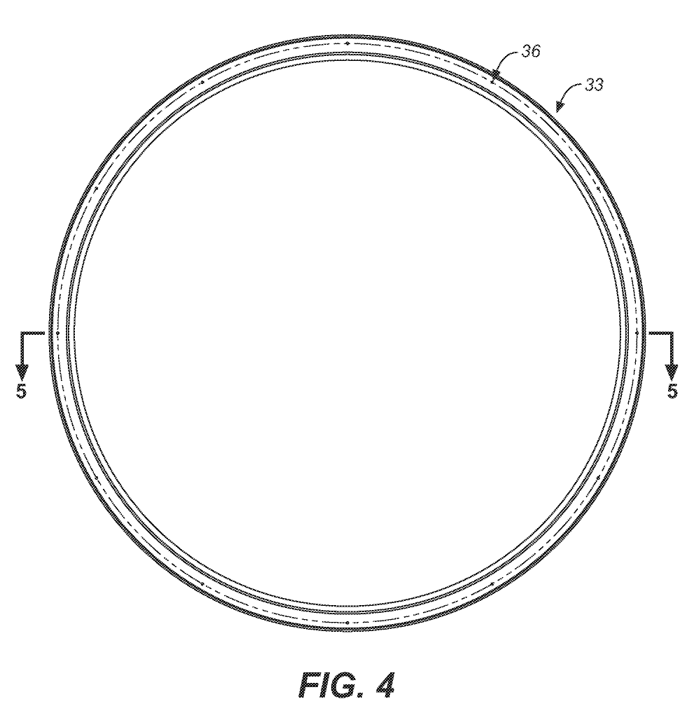

Turning now to the drawings, wherein like components are designated by like reference numerals throughout the various figures, attention is directed to FIG. 1 which shows a radome 30 of the present invention generally enclosing a satellite communications antenna system 32. The radome generally includes a substantially semispherical dome 33 mounted on a base 35, which together serve to enclose the antenna system and shield it from the elements. The radome and antenna is adapted to be mounted on a mast or other suitable portion of a vessel having a satellite communication terminal. The terminal contains communications equipment and otherwise conventional equipment for commanding the antenna to point toward the satellite in elevation and azimuth coordinates.

The antenna system may generally include a circularly symmetric main reflector and feed chain/subreflector combination supported at the apex of the main reflector similar to the Sea Tel® Cobham 6006 antenna system, however, one will appreciate that various antenna systems may utilized with the radome of the present invention, which antenna systems may have a wide variety of dimensions and configurations. The sub-reflector may be a ‘splash plate’ configuration and may be supported at the feed aperture by a dielectric cone similar to the Sea Tel® Cobham 6006 antenna system. The feed chain may include a rotating joint for polarization alignment and a two port Ortho-Mode Transducer (OMT) providing orthogonally polarized transmit and receive functions simultaneously similar to the Sea Tel® Cobham 6006 antenna system. The back port of the OMT may be the transmit port and the side port of the OMT is the receive port similar to the Sea Tel® Cobham 6006 antenna system. The mounting of the feed chain/sub-reflector combination may be located at the apex of the main reflector which supports the feed chain and sub-reflector similar to the Sea Tel® Cobham 6006 antenna system.

The electrical requirements adhere to the policies put forth by the International Telecommunication Union (ITU) and adopted by EUTELSAT for earth station verification. As per the EUTELSAT representative all parameters below must be met inside the radome and looking at an elevation between 35° and 45°. This is considered to be the most popular look angle for users that will be using the EUTELSAT satellites and therefore considered the most accurate look angle for performance measurements. The electrical specifications which antenna systems must adhere to is given in Table 1.

TABLE 1
RF Specifications

| Parameter | Specification | |
|---|---|---|
| Frequency | Rx: 10.70-12.75 GHz | |
| | Tx: 13.75-14.50 GHz | |
| Polarization | Orthogonal Linear | |
| Gain | Rx: ~43.5 dBi @ 11.85 GHz (assuming 65% | |
| | Efficiency) | |
| | Tx: ~45.1 dBi @ 14.25 GHz (assuming 65% | |
| | Efficiency) | |
| Off-axis Co-polar | 29 − 25log(θ) dBi | 100λ/D < θ ≦ 7° |
| Gain | +8 dBi | 7° < θ ≦ 9.2° |
| | 32 − 25log(θ) dBi | 9.2 < θ ≦ 48° |
| | −10 dBi | 48° < G ≦ 180° |
| Allowable Tolerances | 100λ/D < θ ≦ 7° may exceed mask by 3 dB | |
| CoPol | 9.2 < θ ≦ 48° may exceed mask by 6 dB | |
| | 100λ/D < θ ≦ 180 total energy over mask | |
| | may not exceed 10% | |
| Cross-polar Gain | >−35dB Isolation on bore sight | |
| | >−30dB Isolation with the cone angle defined by | |
| | the pointing error or the 1 dB contour which ever | |
| | is greater. | |
| Off-axis Cross-polar | 19 − 25log(θ) dBi | 1.8° < θ ≦ 7° |
| Gain | −2 dBi | 7° < θ ≦ 9.2° |

| | |
|---|---|
| Allowable Tolerances | None |
| XP | |

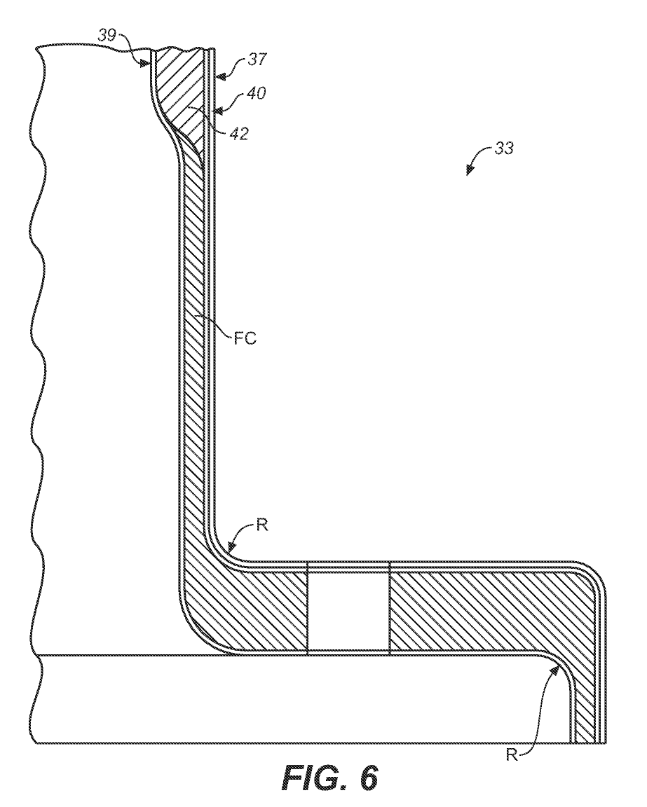

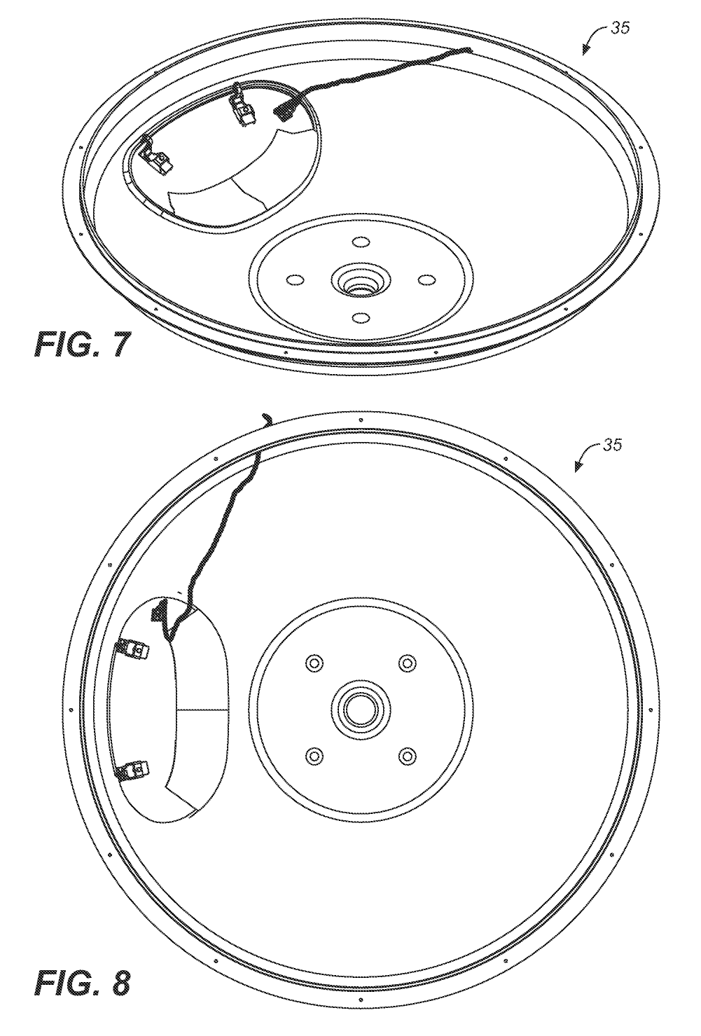

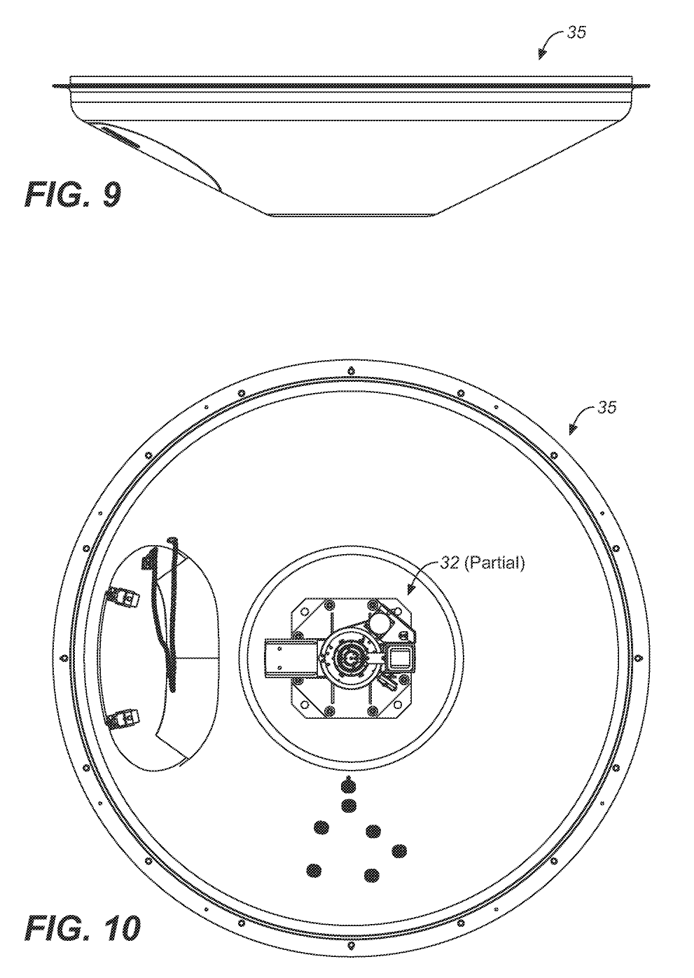

In accordance with the present invention, radome 30 is configured to minimize interference such that antenna system may adhere to the above specifications. The Radome may be a 3 layer unit built using the “A” sandwich technique. The radome may also be covered with a thin layer of gel coat 37 to enhance wear and tear in a demanding marine environment. The “A” sandwich radome construction is designed to provide both good RF performance and high strength to weight performance. The layers include two very thin skins, an inner skin 39 and an outer skin 40, which encapsulate a very low dielectric material layer 42, as shown in FIG. 6. The radome is tuned by manipulating the layers by selectively varying their thickness to provide optimum performance. The radome is considered a “tuned” radome when designed for minimum loss on the bore sight, but more importantly has very good scattering performance off-axis.

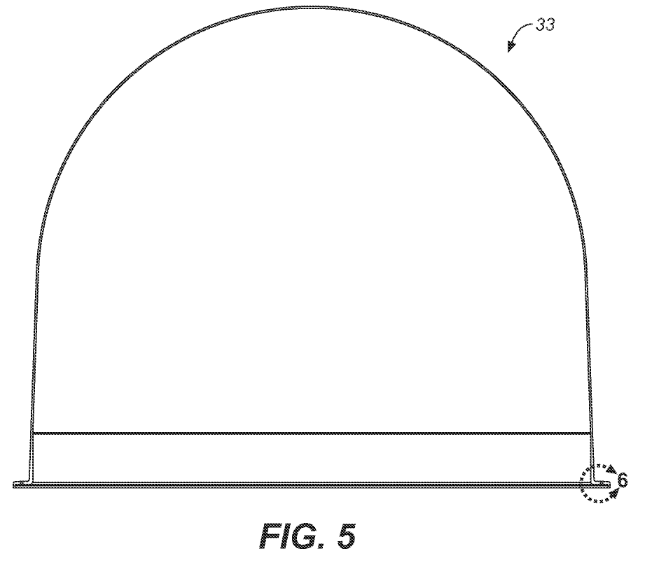

With reference to FIG. 5 and FIG. 6, radome 30 is configured to provide maximum transparency for a wide frequency range, preferably the entire, or substantially the entire Ku band from 10.7 Ghz to 14.4 Ghz. For example, to provide a properly “tuned” radome, the radome may include inner and outer skin thicknesses of approximately 0.007 to 0.027 inches, more preferably approximately 0.014 to 0.020 inches, and most preferably 0.017 inches, and a low dielectric material layer thickness of approximately 0.153 to 0.173 inches, more preferably approximately 0.160 to 0.166 inches, and most preferably 0.163 inches. In instances where a gel coat is provided the gel coat may have a thickness of approximately 0.010 to 0.030 inches, more preferably approximately 0.017 to 0.023 inches, and most preferably 0.020 inches. One will appreciate that the actual thicknesses may vary to some degree to further “tune” the radome to specific frequencies.

Suitable materials for the inner and outer skins include HEXCEL 7500 and/or HEXION 733-8650, however one will appreciate that other suitable materials may be used. Suitable materials for the low dielectric material layer include DIVINYCELL H100, however one will appreciate that other suitable materials may be used. Suitable materials for the gel coat include DURAKOTE 40314950D CCP W005D, however one will appreciate that other suitable materials may be used.

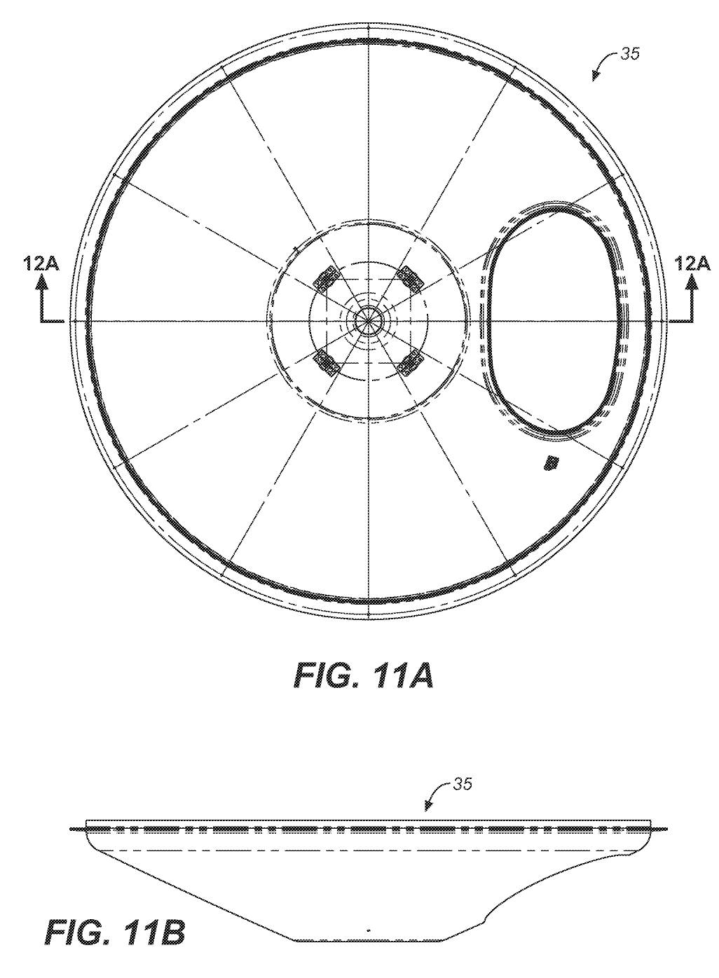

Turning now to FIG. 11A and FIG. 11B, radome base 35 may be tuned to provide it with a desired resonant frequency that is different than that of the tracking antenna. In particular, damage to prior radomes and systems may result from the radome hitting the antenna when the radome resonates at a lower frequency. At lower frequencies, the radome will have a larger range of motion thus increasing the risk of contact with the tracking antenna. By tuning the radome base with a relatively higher resonant frequency, such motion may be reduced thus significantly decreasing the risk of contact.

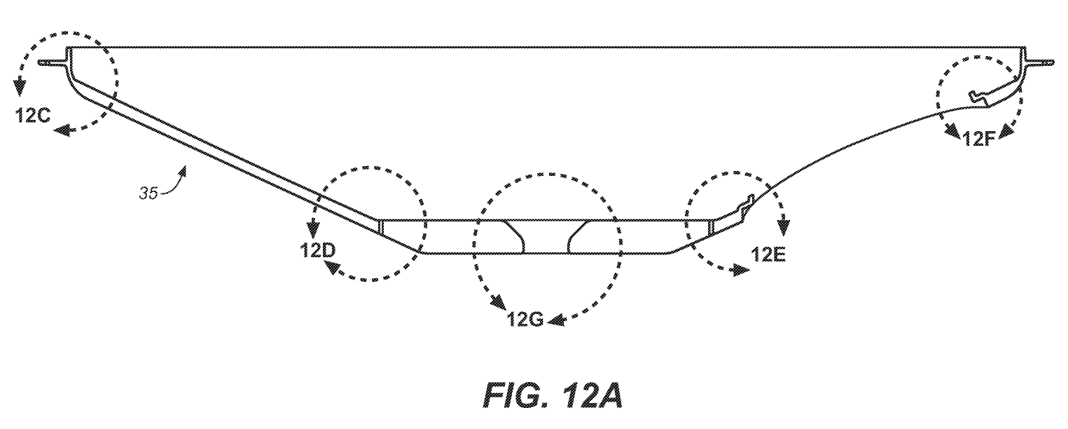

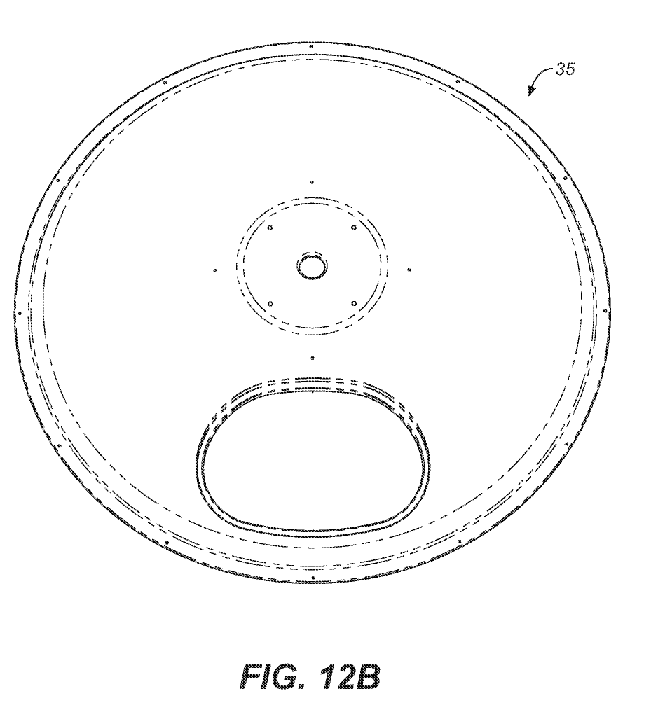

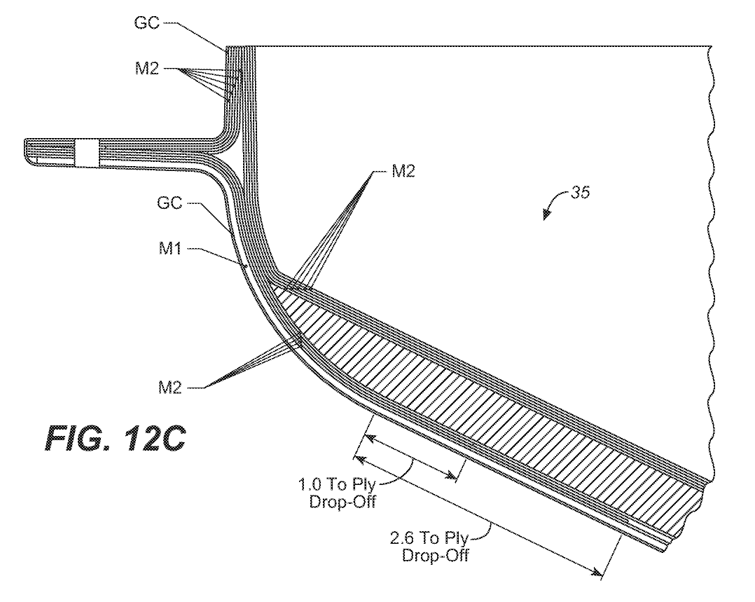

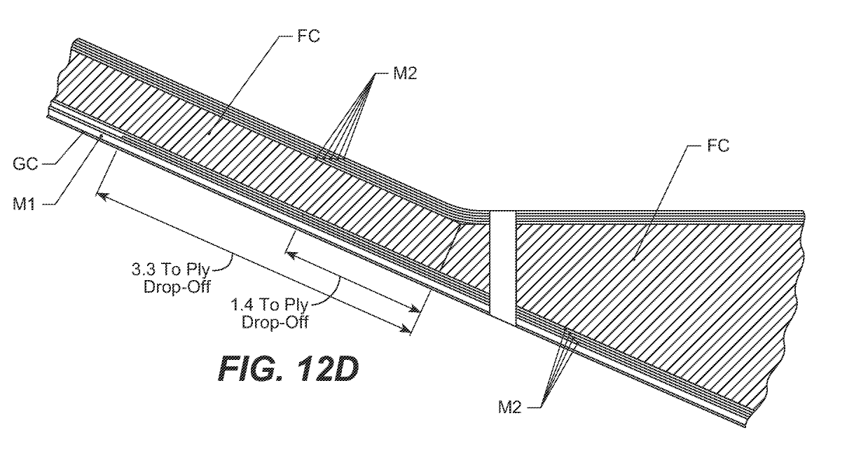

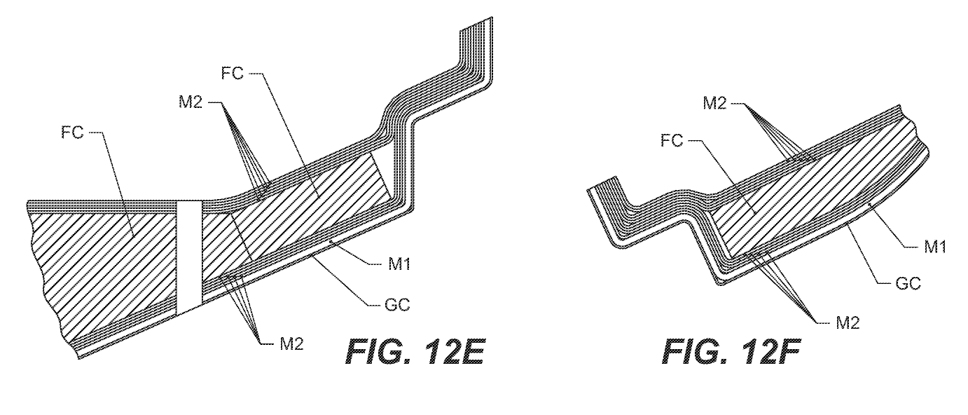

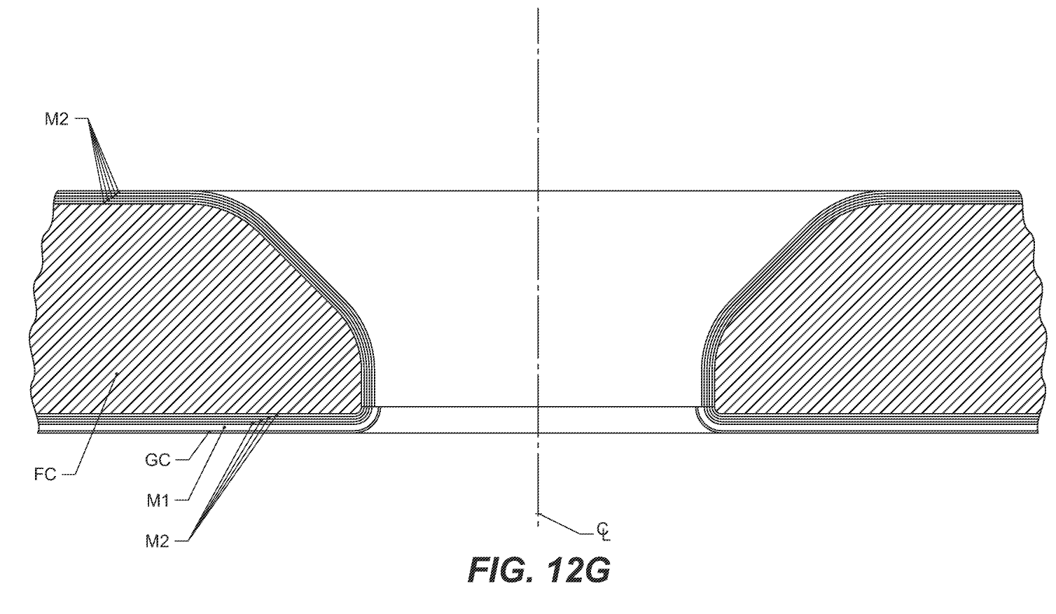

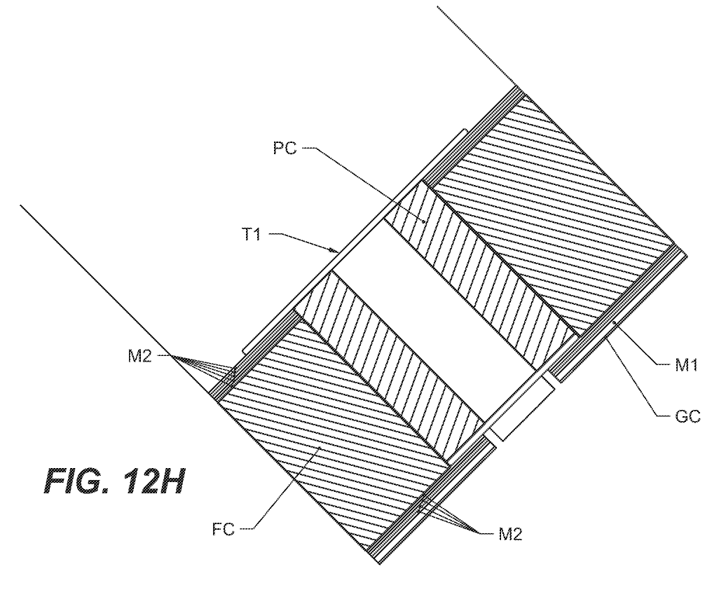

For example, a tracking antenna similar to the Sea Tel® Cobham 6006 antenna system may have a resonant frequency of approximately 3 Hz to 5 Hz. In such case, radome base 35 may be tuned in accordance with the present invention to provide it with a relatively higher resonant frequency, for example, above approximately 10 Hz. One will appreciate that one may adjust various dimensional and geometric features to tune the radome base accordingly. For example, the radome base illustrated in FIG. 12A through FIG. 12 provide for a radome base having a resonant frequency above 10 Hz. One will appreciate that various other configurations may be utilized to provide such a resonant frequency.

With reference to FIG. 12A through FIG. 12H, radome base 35 is a 66″ tuned base, however, one will appreciate that the actual dimensions of the base may vary depending upon the dimensions and configurations of the supported tracking antenna. The base may include a gel coat GC, one or more layers of COMBIFLOW® molding mat Ml, one or more layers of DOUBLE BIAS mat, and a DIVINYCELL H80 foam core FC as illustrated in FIG. 12A through FIG. 12H. One will appreciate that the radome base may be formed of other suitable materials. One will also appreciate that the layer thicknesses and number of layers may also be varied to further tune the base in accordance with known methods.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A radome for a tracking antenna, the radome comprising:
a dome for covering the tracking antenna;
wherein the dome includes a dome wall having inner and outer skins sandwiching a low dielectric material layer therebetween; and
wherein the dome wall includes a gel coat layer covering the outer skin to protect the dome in a marine environment.

2. A radome for tracking antenna according to claim 1, wherein the inner and outer skins have a thicknesses of approximately 0.007 to 0.027 inches, more preferably approximately 0.014 to 0.020 inches, and most preferably 0.017 inches.

3. A radome for tracking antenna according to claim 1, wherein the low dielectric material layer has a thickness of approximately 0.153 to 0.173 inches, more preferably approximately 0.160 to 0.166 inches, and most preferably 0.163 inches.

4. A radome for tracking antenna according to claim 1, wherein the gel coat has a thickness of approximately 0.010 to 0.030 inches, more preferably approximately 0.017 to 0.023 inches, and most preferably 0.020 inches.

5. A radome for a tracking antenna, the radome comprising:
a dome for covering the tracking antenna;
wherein the dome includes a dome wall having inner and outer skins sandwiching a low dielectric material layer therebetween;
wherein the inner and outer skins have a thicknesses of approximately 0.007 to 0.027 inches, more preferably approximately 0.014 to 0.020 inches, and most preferably 0.017 inches; and
wherein the low dielectric material layer has a thickness of approximately 0.153 to 0.173 inches, more preferably approximately 0.160 to 0.166 inches, and most preferably 0.163 inches.

6. A tracking antenna system, the system comprising:
a tracking antenna having a first resonant frequency; and
a radome including a base for supporting the tracking antenna and a dome secured to the base for enclosing the tracking antenna;
wherein the base has a second resonant frequency above the first resonant frequency.

7. A radome for tracking antenna according to claim 6, wherein the first resonant frequency is approximately 3 Hz to 5 Hz.

8. A radome for tracking antenna according to claim 6, wherein the second resonant frequency is at least approximately 10 Hz.

9. A radome for tracking antenna according to claim 6, wherein the base includes a smooth circular body.

10. A radome for tracking antenna according to claim 9, wherein the smooth circular body has a frustoconical shape.
